(19) United States
(12) Patent Application Publication
(10) Pub. No.: US 2025/0168266 A1
(43) Pub. Date: May 22, 2025

(54) Mobile Computing Device Accessory

(71) Applicant: ZEBRA TECHNOLOGIES CORPORATION, Lincolnshire, IL (US)

(72) Inventors: Josh Gregory, Southampton (GB); Mark Thomas Fountain, Hitchin (GB)

(21) Appl. No.: 18/513,295

(22) Filed: Nov. 17, 2023

(51) Int. Cl. H04M 1/02

(52) U.S. Cl. CPC H04M 1/0279

(57) ABSTRACT

An example disclosed accessory for a mobile computing device includes a pivot assembly, a hand strap assembly, and a kickstand assembly. The hand strap assembly connected to the pivot assembly and configured to rotate about a first axis between a vertical orientation and a horizontal orientation. The kickstand assembly connected to the pivot assembly and configured to pivot about a second axis, the second axis orthogonal to the first axis, between a support position and a closed position.

### BACKGROUND OF THE INVENTION

As mobile computing communication devices become more common, various accessories exist to facilitate mobile device use in different and more natural ways, improving the user experience.

### SUMMARY

An example embodiment described herein includes an accessory for a mobile computing device that includes a pivot assembly, a hand strap assembly, and a kickstand assembly. The hand strap assembly connected to the pivot assembly and configured to rotate about a first axis between a vertical orientation and a horizontal orientation The kickstand assembly connected to the pivot assembly and configured to pivot about a second axis, the second axis orthogonal to the first axis, between a support position and a closed position.

In further embodiments, the hand strap assembly is rotatably secured to the pivot assembly, the hand strap configured to rotate with a biased cam.

In another embodiment, the kickstand assembly is secured to the pivot assembly via a pivot axle, wherein the pivot axle includes at least one bracket to secure the pivot axle to the pivot assembly.

In other embodiments, the hand strap assembly is rotatable in relation to the pivot assembly. Additionally, the hand strap assembly is rotatable from a vertical position in 90 degrees either clockwise or counterclockwise.

In further embodiments, the biased cam includes at least one tab and a biaser connector, the at least one tab is configured to mate with a detent of the pivot assembly when the hand strap assembly is rotated to a horizontal orientation.

In another embodiment, the accessory of claim 1, further includes a biaser secured between the pivot assembly and the biaser connector on the biased cam, the biaser is configured to apply a force to the biased cam, via the biaser connector, towards vertical orientation.

In further embodiments, the pivot axle of the kickstand assembly is rigidly connected to at least one kickstand prop, wherein the kickstand prop is configured to support the mobile computing device when the kickstand assembly is in the support position. Additionally, the kickstand assembly further comprises a second kickstand prop.

In further embodiments, when the kickstand assembly is in the support position, the kickstand assembly is configured to support the mobile computing device in either a landscape orientation or a portrait orientation.

An example embodiment described herein includes a mobile computing device includes a pivot assembly; a hand strap assembly; and a kickstand assembly. The pivot assembly secured to a rear surface of the mobile computing device. The hand strap assembly connected to the pivot assembly and configured to rotate about a first axis between a vertical orientation and a horizontal orientation. The kickstand assembly connected to the pivot assembly and configured to pivot about a second axis, the second axis orthogonal to the first axis, between a support position and a closed position.

In a further embodiment, the hand strap assembly is rotatably secured to the pivot assembly and the hand strap assembly is configured to rotate with a biased cam.

In another embodiment, the kickstand assembly is secured to the pivot assembly via a pivot axle, wherein the pivot axle includes at least one bracket to secure the pivot axle to the pivot assembly.

A further embodiment includes the biased cam comprises at least one tab and a biaser connector, the at least one tab is configured to mate with a detent of the pivot assembly when the hand strap assembly is rotated to a horizontal orientation.

In another embodiment, a biaser secured between the pivot assembly and the biaser connector on the biased cam, the biaser is configured to apply a force to the biased cam, via the biaser connector, towards vertical orientation.

In another embodiment, the pivot axle of the kickstand assembly is rigidly connected to at least one kickstand prop, wherein the kickstand prop is configured to support the mobile computing device when the kickstand assembly is in the support position. Further, when the kickstand assembly is in the support position, the kickstand assembly is configured to support the mobile computing device in either a landscape orientation or a portrait orientation.

In a further embodiment, the mobile computing device includes a battery, the battery being inaccessible when the hand strap assembly is in the vertical orientation, and the battery being accessible when the hand strap assembly is in the horizontal position.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an isometric view of an accessory mounted to the rear of a mobile computing device according to example embodiments of the present disclosure;

FIG. 2A illustrates a front view of the accessory of FIG. 1 where a hand strap assembly is in a vertical orientation according to example embodiments of the present disclosure;

FIG. 2B illustrates a rear view of the accessory of FIG. 2A according to example embodiments of the present disclosure;

FIG. 3A illustrates a front view of the accessory of FIG. 1 where a hand strap assembly is in a horizontal orientation according to example embodiments of the present disclosure;

FIG. 3B illustrates a rear view of the accessory of FIG. 3A according to example embodiments of the present disclosure;

FIG. 4 illustrates an exploded view of the accessory of FIG. 1 according to example embodiments of the present disclosure; and

FIG. 5 illustrates multiple views of the accessory of FIG. 1 according to example embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

The disclosed embodiments will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout.

Mobile computing devices such as tablets are being used in retail or factory settings where modularity and variability of design can be valuable. In using the mobile computing devices, a user may need to quickly transition the mobile computing device from being held by the user to being propped up on a surface for viewing. Simultaneously, as the mobile computing device may be installed in different types of mounts such as a docking feature or a vehicle mount, it would be advantageous for any accessory for the mobile computing device to be low profile such that it can lay flat near the back surface of the mobile computing device. Thus, an accessory that can facilitate holding the mobile computing device, providing a method for resting the mobile computing device for viewing while maintaining a thin profile for vehicle mounting is desired.

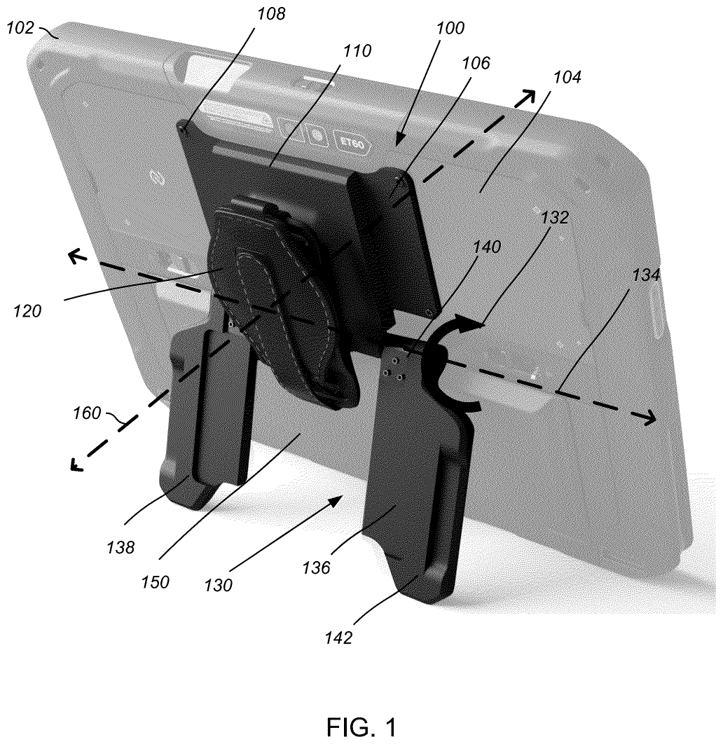

As illustrated in FIG. 1, the assembly 100 can be used on a back surface 104 of a mobile computing device 102, such as a tablet. The assembly 100 is configured to mount to the back surface 104 via a mounting plate 106. The mounting plate 106 is connected to a pivot assembly 110. The pivot assembly 110 fastened to a hand strap assembly 120 such that the hand strap assembly 120 is configured to rotate with respect to the pivot assembly 110. FIG. 1 further depicts a kickstand assembly 130, the kickstand assembly 130 is secured to the pivot assembly 110.

As depicted in FIG. 1, the kickstand assembly 130 is in an extended position. The kickstand assembly is configured to, from the extended position 130, to pivot about a second axis 134 in a direction indicated by arrow 132 until the kickstand assembly is in the closed position (described further below). The kickstand assembly includes a first prop 136 and a second prop 138 (collectively props 136). The props 136 are configured to support the device 102 in a tilted position as depicted in FIG. 1. The props 136 have a top end 140 with a hinge element (discussed below) and a bottom end 142 to rest against a surface to support the tablet 102.

As depicted in FIG. 1, the hand strap assembly 120 is in a vertical position. As will be discussed further below, the hand strap assembly 120 is biased to the vertical position but is capable of rotating about a first axis 160 passing through a pivot connection between the hand strap assembly 120 and the pivot assembly 110. The hand strap assembly 120 is capable of rotating either clockwise or counterclockwise. As depicted in FIG. 1, the first axis 160 and the second axis 134 are orthogonal.

In the depicted embodiment, the mounting plate 106 is attached to the back surface 104 of the tablet 102 using at least one fastener 108. The mounting plate 106 may be shaped to fit to the back surface 104 such that the mounting plate 106 avoids pertinent areas on the back of the tablet, such as a camera area, a fan area or a battery pack area 150. With regard to the battery pack area 150, in some embodiments, the hand strap assembly 120 may partially overlap the battery pack area 150 while in the vertical orientation as shown in FIG. 1. In this scenario, it is advantageous for the hand strap assembly to rotate to a horizontal orientation and maintain the horizontal orientation until acted on by a user. This is addressed by internal components of the pivot assembly, which will be discussed in further detail below. When the hand strap assembly is in the horizontal orientation, then the battery area 150 is accessible. When the hand strap assembly is in a vertical orientation, then the battery pack is partially covered by the hand strap assembly 120 and may be inaccessible.

While FIG. 1 depicts the hand strap assembly in the vertical orientation and the kickstand assembly in the support position, when the hand strap assembly is in the horizontal orientation, the kickstand assembly may be unable to change position.

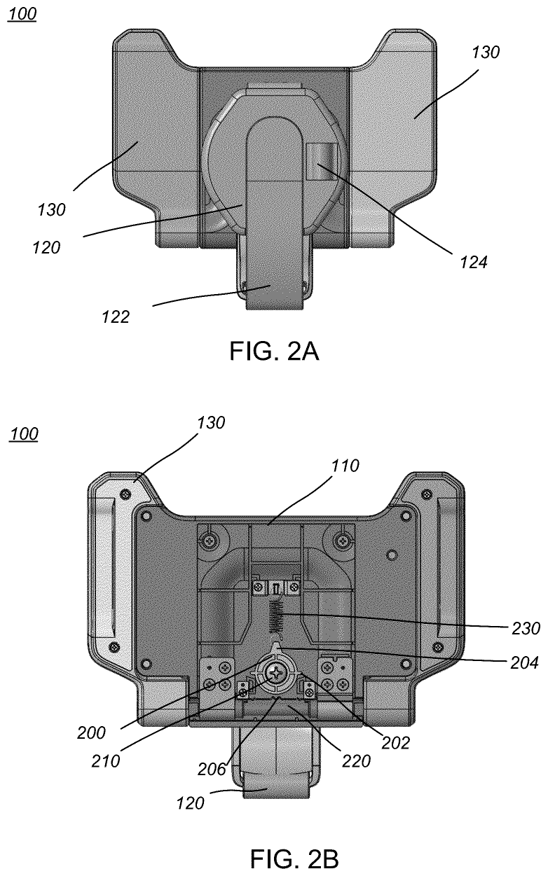

FIGS. 2A and 2B depict depicts the assembly with the kickstand assembly 130 in a retracted position, and the hand strap assembly 120 in a vertical orientation. FIG. 2A depicts a first side of the assembly while FIG. 2B depicts a second side opposite the first side.

As depicted in FIG. 2A, the hand strap assembly 120 as depicted in FIG. 2A includes a clip element 122, and a stylus holder 124. The clip element 122 is configured to fasten the assembly 100 and any tablet 100 secured to the assembly 100 onto a user's belt, pockets, surface, or bag. The stylus holder 124 is configured to hold writing or stylus instruments such as pens, pencil, stylus, or any other thin tool that will be required by the user. In the depicted embodiment, the stylus holder 124 is configured to hold a stylus parallel with the hand strap assembly 120. By having the stylus holder 124 parallel to the hand strap 120, any stylus within the holder 124 would be able to lie adjacent to the hand strap should the device 102 be loaded into a mount having a recess configured to receive the hand strap assembly 120, such recess would also be able to receive the stylus. FIG. 2B depict the second side of the pivot assembly 110.

As illustrated, the pivot assembly 110 includes a biased cam (or cam) 200, a pivot fastener 210, a kickstand axle 220, and a spring 230. The cam 200 includes a biased connector 204 and at least one tab 202. In other embodiments, there are at least two tabs 202 on the cam 200, where the tabs 202, as depicted at opposite the other on the cam 200. The biased connector 204 is configured to connect to the spring (or biaser) 230. The spring 230 is configured to be restrained to the rear of the pivot assembly 110 on one end and to the biased connector 204 on the other. The spring 230 is configured to apply a force on the cam 200 which forces the cam 200 to the orientation as shown in FIG. 2B, such that the biased connector 204 is directed at the other mounting point of the spring 230. The tabs 202 and the detent 206 will be discussed further below.
FIG. 2B also depicts the axle 220 of the kick stand assembly 130. The axle 220 is configured to be rotatably supported by the axle brackets 222 and rigidly connected to the props of the kickstand assembly.

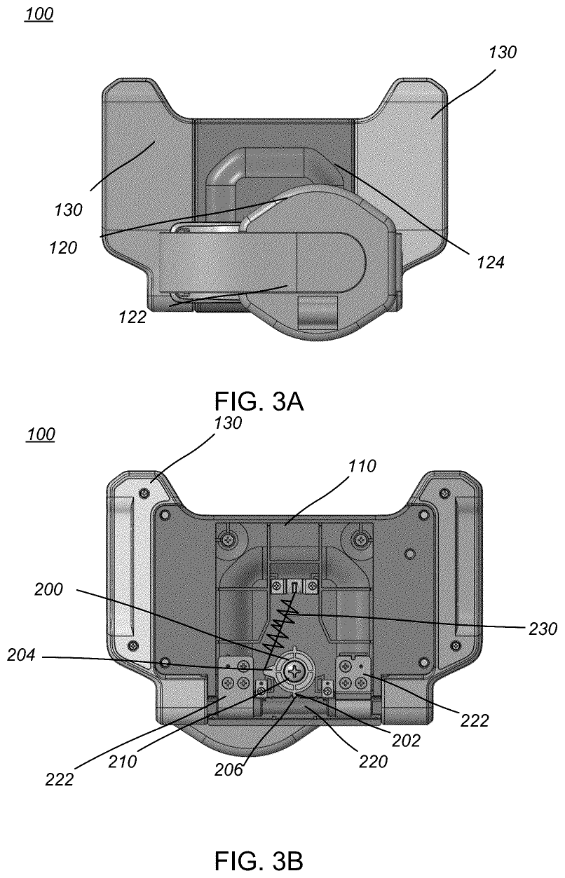

FIGS. 3A and 3B depict depicts the assembly with the kickstand assembly 130 in a retracted position, and the hand strap assembly 120 in a horizontal orientation respective to the pivot assembly and the kickstand assembly. FIG. 3A depicts a first side of the assembly while FIG. 3B depicts a second side opposite the first side.

As seen in FIG. 3B, the cam 200 has been rotated via the rotation of the hand strap assembly 120. The hand strap assembly 120 rotates concentrically with the cam 200 such that the biased connector of the cam 200 is aligned with the hand strap assembly 120. As the cam 200 rotates from a vertical position to the horizontal position, the spring 230 is stretched such that a force builds up to resist the movement of the cam 200 away from the spring 230. If the cam 200 and hand strap 120 is rotated to 90 degrees from vertical, a tab 202 located on a side of the cam 200 is secured by the detent 206. The tab 202 passes over the detent 206. In the depicted embodiment, the detent 206 is made of a thin piece of metal which is configured to flex away from the tab 202 when the tab 202 comes into contact with the detent 206. The tab 202 is may then be configured to be retained within the detent 206 until a user applies appropriate force to the hand strap assembly 120 to move the hand strap assembly back to a vertical orientation.

As depicted in FIG. 3B, fastener 210 is configured to secure the hand strap assembly 120 to the pivot assembly 110. In the depicted embodiment the fastener 210 is a screw, however it can be any type of known fastener that is capable of securing objects along a rotatable axis. The fastener 210 passes through the cam 200, the pivot assembly 110, and is received by the hand strap assembly 120. This will be shown in better detail below.

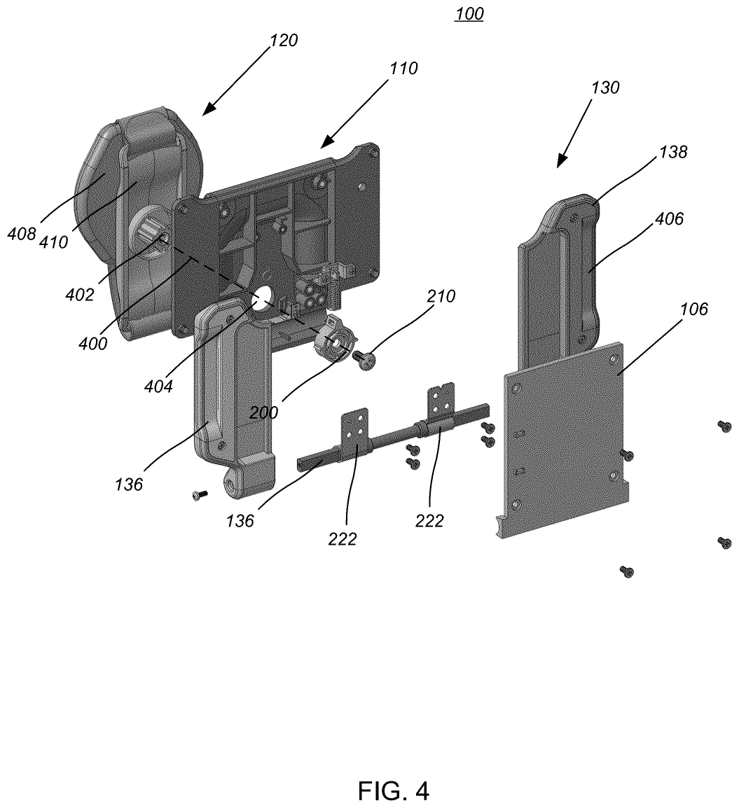

FIG. 4 depicts an exploded view of the assembly 100. The hand strap assembly 120 has a hand strap connector 402 which is aligned along a hand strap rotation axis 400. The hand strap rotation axis 400 passes from the hand strap connector 402, through an opening 404 in the pivot assembly 110. The hand strap assembly 120 further includes a strap element 408 and a hand strap base element 410, wherein the strap element 408 is configured to fit around a user's hand.

The pivot assembly is configured to be mounted to the mounting plate 106 which contains the brackets 222 and the cam 200 within the pivot assembly 110. The kickstand props 138 contain a finger ledge 406, where the finger ledge 406 is configured to allow a user to get their fingers below the side wall of the kickstand prop 138 to manually pivot them from between positions.

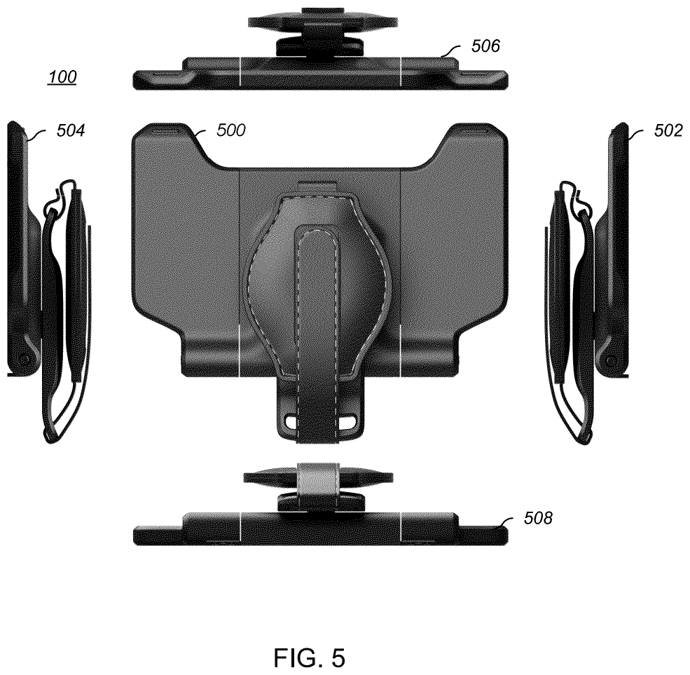

FIG. 5 depicts the assembly 100 from multiple views. In the middle of FIG. 5 is a front view 500. FIG. 5 further depicts a first side view 502, a second side view 504, a top view 506 and a bottom view 508.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

That which is claimed:

1. An accessory for a mobile computing device, the accessory comprising:
a pivot assembly;
a hand strap assembly connected to the pivot assembly and configured to rotate about a first axis between a vertical orientation and a horizontal orientation; and
a kickstand assembly connected to the pivot assembly and configured to pivot about a second axis, the second axis orthogonal to the first axis, between a support position and a closed position.

2. The accessory of claim 1, wherein the hand strap assembly is rotatably secured to the pivot assembly, the hand strap configured to rotate with a biased cam.

3. The accessory of claim 1, wherein the kickstand assembly is secured to the pivot assembly via a pivot axle, wherein the pivot axle includes at least one bracket to secure the pivot axle to the pivot assembly.

4. The accessory of claim 1, wherein the hand strap assembly is rotatable in relation to the pivot assembly.

5. The accessory of claim 2, wherein the hand strap assembly rotatable from a vertical position in 90 degrees either clockwise or counterclockwise.

6. The accessory of claim 2, wherein the biased cam comprises at least one tab and a biaser connector, the at least one tab is configured to mate with a detent of the pivot assembly when the hand strap assembly is rotated to a horizontal orientation.

7. The accessory of claim 2, further comprising a biaser secured between the pivot assembly and the biaser connector on the biased cam, the biaser is configured to apply a force to the biased cam, via the biaser connector, towards vertical orientation.

8. The accessory of claim 3, wherein the pivot axle of the kickstand assembly is rigidly connected to at least one kickstand prop, wherein the kickstand prop is configured to support the mobile computing device when the kickstand assembly is in the support position.

9. The accessory of claim 8, wherein the kickstand assembly further comprises a second kickstand prop.

10. The accessory of claim 1, wherein when the kickstand assembly is in the support position, the kickstand assembly is configured to support the mobile computing device in either a landscape orientation or a portrait orientation.

11. A mobile computing device comprising:
a pivot assembly secured to a rear surface of the mobile computing device;
a hand strap assembly connected to the pivot assembly and configured to rotate about a first axis between a vertical orientation and a horizontal orientation; and
a kickstand assembly connected to the pivot assembly and configured to pivot about a second axis, the second axis orthogonal to the first axis, between a support position and a closed position.

12. The mobile computing device of claim 11, wherein the hand strap assembly is rotatably secured to the pivot assembly, the hand strap configured to rotate with a biased cam.

13. The mobile computing device of claim 11, wherein the kickstand assembly is secured to the pivot assembly via a pivot axle, wherein the pivot axle includes at least one bracket to secure the pivot axle to the pivot assembly.

14. The mobile computing device of claim 12, wherein the biased cam comprises at least one tab and a biaser connector, the at least one tab is configured to mate with a detent of the pivot assembly when the hand strap assembly is rotated to a horizontal orientation.

15. The mobile computing device of claim 14, further comprising a biaser secured between the pivot assembly and the biaser connector on the biased cam, the biaser is configured to apply a force to the biased cam, via the biaser connector, towards vertical orientation.

16. The mobile computing device of claim 13, wherein the pivot axle of the kickstand assembly is rigidly connected to at least one kickstand prop, wherein the kickstand prop is configured to support the mobile computing device when the kickstand assembly is in the support position.

17. The mobile computing device of claim 16, wherein when the kickstand assembly is in the support position, the kickstand assembly is configured to support the mobile computing device in either a landscape orientation or a portrait orientation.

18. The mobile computing device of claim 11, wherein the mobile computing device includes a battery, the battery being inaccessible when the hand strap assembly is in the vertical orientation, and the battery being accessible when the hand strap assembly is in the horizontal position.
